(19) United States
(12) Patent Application Publication
(10) Pub. No.: US 2012/0093496 A1
(43) Pub. Date: Apr. 19, 2012

(54) CAMERA DRIVING DEVICE

(75) Inventors: KAO-CHI LIU, TAIPEI CITY (TW); CHAO-HSI WANG, HSINCHU COUNTY (TW)

(73) Assignee: VI-TAI TECHNOLOGY CO., LTD., NEW TAIPEI CITY (TW)

(21) Appl. No.: 13/217,511

(22) Filed: Aug. 25, 2011

(30) Foreign Application Priority Data
Oct. 15, 2010 (TW) 99219992

(51) Int. Cl. G03B 17/00

(52) U.S. Cl. 396/439

(57) ABSTRACT

A camera driving device, including: a base frame, a magnetic rotating member, a yoke, and a coil. The magnetic rotating member is structured in one piece and includes a first and second magnetic pole that are opposite in polarity; the magnetic rotating member is formed with a base plate and a swing shaft extending from the base plate. The magnetic rotating member is coupled to the base frame, and the swing shaft is positioned at a side of base plate away from the base frame. The yoke is installed at the base frame, and the two terminus of the yoke is positioned to one side of the magnetic rotating member. The coil is wrapped on the yoke. Therein, the magnetic rotating member can rotate between a first and second position.

### BACKGROUND OF THE INVENTION

1. Field of the Invention

The present invention relates to a driving device; in particular, to a camera driving device.

2. Description of Related Art

Today's electronic devices such as notebook computers or mobile phones all contains small sized camera, such as still image or video camera.

Reference FIG. 1, which shows a rotator piece 1a used by prior art camera driving device. The rotator piece 1a includes a magnetic rotating member 11a and a plastic casing 12a formed outside of the magnetic rotating member 11a. Therefore with this type of rotator piece 1a structure, it is hard to increase the component ratio for magnetic rotating member 11a, therefore likely to result in difficulty in designing miniaturized driving device.

Furthermore, prior art rotator piece 1a structure requires two processing sequence for formation, which includes first placing magnetic rotating member 11a within a module, then utilizing embed and eject formation method for forming the plastic casing 12a outside of magnetic rotating member 11a. Therefore prior art rotator piece 1a structure requires a higher manufacturing cost.

In addition, the prior art magnetic rotating member is a magnetic block by sintering, that is to say, each portion of the magnetic rotating member is capability of magnetism, such as the applicant's application, wherein the publication number of the applicant's application is US 2011/0116783 A1. When the magnetism of the magnetic rotating member needs to be increased or decreased, the magnetic rotating member must be resized accordingly.

Thus, inventor of the present invention feel that the aforementioned shortcomings can be improved, and so researched and studied, so as to provide present invention that is logically designed and may effectively improve the aforementioned shortcomings.

### SUMMARY OF THE INVENTION

The object of the present invention is to provide a camera driving device, for aiding in designing miniaturized camera driving device, and for decreasing manufacturing cost through the magnetic rotating member structure design of the driving device

In order to achieve the aforementioned objects, according to an embodiment of the present invention, a camera driving device is provided, which includes: a base frame; a magnetic rotating member, structured in one piece and includes a first magnetic pole and a second magnetic pole that are opposite in polarity, wherein the magnetic rotating member is a bonding structure having a plurality of magnetic particles, the magnetic rotating member is formed with a base plate and a swing shaft extending from the base plate, the magnetic rotating member is coupled to the base frame, and the swing shaft is positioned at a side of the base plate that is away from the base frame; a yoke, installed at the base frame, and the two terminus of the yoke is positioned to one side of the magnetic rotating member; and a coil for magnetic excitation, wrapped on the yoke, and the coil is installed at the base frame; wherein, the swing shaft can rotate between a first position and a second position.

According to another embodiment of the present invention a camera driving device is provided, which includes: a base frame; a magnetic rotating member, structured in one piece and includes a first magnetic pole and a second magnetic pole that are opposite in polarity, wherein the magnetic rotating member is a bonding structure having a plurality of magnetic particles, the magnetic rotating member is formed with a base plate and a swing shaft extending from the base plate, the magnetic rotating member is coupled to the base frame, and the swing shaft is positioned at a side of the base plate that is away from the base frame, the magnetic rotating member forms two opposing magnetic areas of the first magnetic pole and two opposing magnetic areas of the second magnetic pole, the magnetic areas for the first magnetic pole and the second magnetic pole are arranged in a crisscross way, and the swing shaft can rotate between a first position and a second position.

Per aforementioned, as compared to the prior art, the embodiments of the present invention provide a rotating member with better rotating effect when driven by the magnetic force of a yoke, and is advantageous for decreasing the overall structural size of the driving device. Furthermore, the magnetic rotating member structure for the driving device is helpful in decreasing manufacturing cost.

In order to further the understanding regarding the present invention, the following embodiments are provided along with illustrations to facilitate the disclosure of the present invention.

### BRIEF DESCRIPTION OF THE DRAWINGS

FIG. 1 shows a cross-sectional diagram of a rotator piece of a camera driving device according prior art;

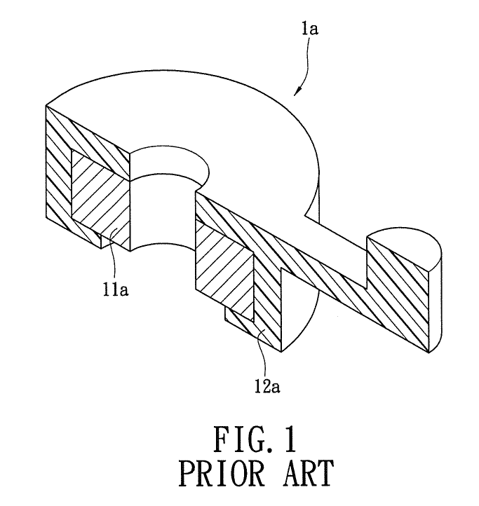

FIG. 2 shows a component assembly diagram according to a first embodiment of the present invention;

FIG. 3 shows a perspective diagram of a magnetic rotating member located at a first position according to the first embodiment of the present invention;

FIG. 4 shows a perspective diagram of the magnetic rotating member located at a second position according to the first embodiment of the present invention;

FIG. 5 shows a perspective diagram of the magnetic rotating member and a leaf blade located at the first position according to the first embodiment of the present invention;

FIG. 6 shows a perspective diagram of the magnetic rotating member and the leaf blade located at the second position according to the first embodiment of the present invention;

FIG. 7 shows a component assembly diagram according to a second embodiment of the present invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

### The First Embodiment

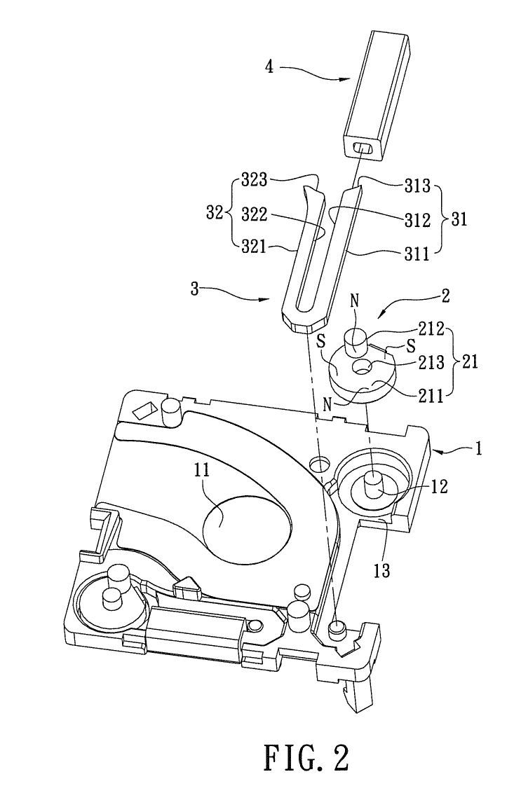

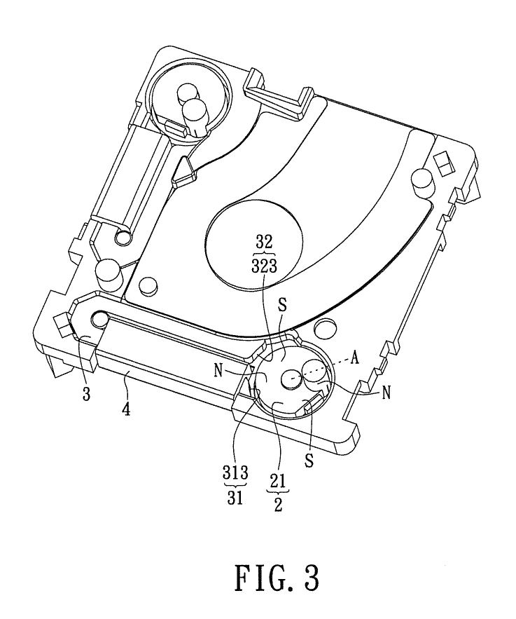

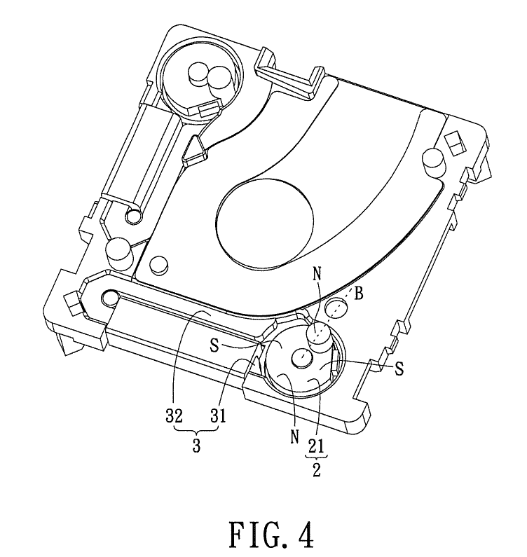

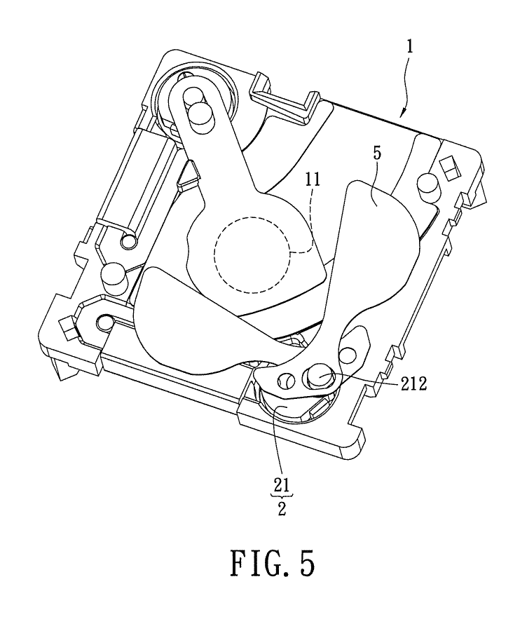

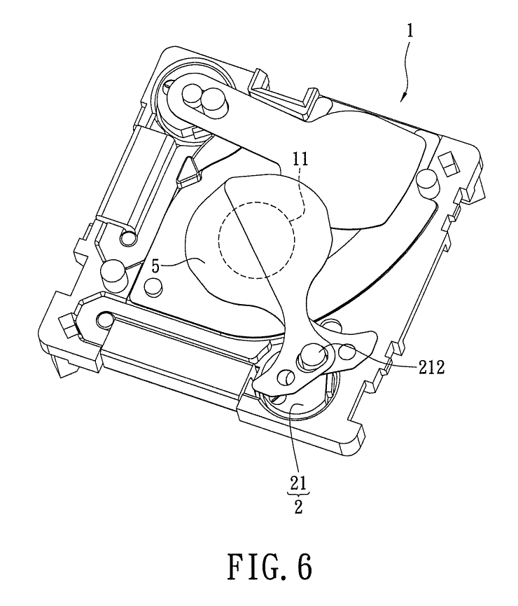

Reference FIGS. 2 to 6, which shows the first embodiment of the present invention, wherein, FIG. 2 shows a component assembly diagram according to present embodiment; FIG. 3 shows a perspective diagram of a magnetic rotating member with the swing shaft thereof located at a first position according to present embodiment; FIG. 4 shows a perspective diagram of the magnetic rotating member with the swing shaft thereof located at a second position according to present embodiment; FIG. 5 shows a perspective diagram of the magnetic rotating member and a leaf blade located at the first position according to the present embodiment; FIG. 6 shows a perspective diagram of the magnetic rotating member and the leaf blade located at the second position according to the present embodiment.

Reference FIG. 2 once again, which shows a camera driving device, including a base frame 1, a rotator piece 2, a yoke 3, and a coil 4 for magnetic excitation (induction). The base frame 1 includes an aperture 11, a cylindrical shaped convex axle 12, and a container slot 13.

The rotator piece 2 comprises a magnetic rotating member 21, which is a bonding structure having a plurality of magnetic particles. That is to say, a binding agent (such as resin) agglomerates the magnetic particles, and then allowing the binding agent to harden, so that the magnetic particles and the harden binding agent form the bonding structure. The manufacturing method of the magnetic rotating member 21 is formed primarily with the magnetic particles and the binding agent through injection molding as one integral piece. In addition, the volume of the magnetic particles divided by the volume of the magnetic rotating member 21 is approximately 0.2 to 0.9, preferably in the range of 0.5 to 0.7. Thus, When the magnetism of the magnetic rotating member needs to be increased or decreased and maintains the volume of the magnetic rotating member 21 at the same time, the amount of magnetic particles inside the magnetic rotating member 21 can be adjusted to change the strength of the magnetism.

Moreover, the magnetic rotating member 21 is of integral one-piece construction and formed with a base plate 211 and a swing shaft 212 extending from the base plate 211. The center of the base plate 211 is arranged with a cylindrical shaped opening 213 that is corresponding adaptable onto the convex axle 12 of the base frame 1. The magnetic rotating member 21 is rotatably coupled to the convex axle 12 of the base frame 1 through the opening 213. The swing shaft is positioned at a side of the base plate 211 that is away from the base frame 1, and the swing shaft 212 is configured to rotate between the first position A (as shown in FIG. 3) and the second position B (as shown in FIG. 4).

Furthermore, the magnetic rotating member 21 includes a first magnetic pole N and a second magnetic pole S that are opposite in polarity, the surrounding of the opening 213 of the magnetic rotating member 21 forms two opposing magnetic areas of the first magnetic pole N and two opposing magnetic areas of the second magnetic pole S, and the magnetic areas for the first magnetic pole N and the second magnetic pole S are arranged in a crisscross way.

Through the aforementioned structure design of the magnetic rotating member 21 (which includes the base plate 211 and the swing shaft 212 that are magnetic), the rotator piece 2 of the present invention only requires one processing sequence for manufacturing formation, additionally the design allows for a high degree of space utilization and component structural ratio.

The yoke 3 is formed with a first exciter (induction pole) portion 31 and a second exciter (induction pole) portion 32 that is connects with the first exciter portion 31. The first exciter portion 31 and the second exciter portion 32 respectively includes an inner terminus 312, 322, an outer terminus 311, 321, and an end surface 313, 323 that connects with the inner terminus 312, 322 and the outer terminus 311, 321. Therein, the outer terminus 311, 321 of the first exciter portion 31 and the second exciter portion 32 is longer than the inner terminus 312, 322, the end surface 313, 323 of the first exciter portion 31 and the second exciter portion 32 presents an arc-shaped curve surface that is recessed inward (as shown in FIG. 3). The two terminus of the yoke 3 are respectively positioned to one side of the first magnetic pole N of the magnetic rotating member 21 and the second magnetic pole S of the magnetic rotating member 21, and the two end surface 313, 323 is approximately in parallel with the peripheral of the magnetic rotating member 21.

Reference FIGS. 3 and 4, the following describes the actual operation of the camera driving device according to the present invention.

The coil 4 is wrapped on the first exciter portion 31 on one end of the yoke 3, and the coil 4 is electrically coupled to an electrical source (not shown), so as to generate a magnetic field via electrical excitation of the yoke 3. Therein, when the coil 4 is not conducted, the magnetic rotating member 21 is located at the first position A (as shown in FIG. 3).

When the magnetic rotating member 21 is located at the first position A and the coil 4 conducts a first electric current, the two terminus of the yoke 3 formed via the first exciter portion 31 and the second exciter portion 32 generates magnetic field. Thereby, the magnetic field generated by the first exciter portion 31 and the second exciter portion 32 is repelled with the magnetic rotating member 21, so that the magnetic rotating member 21 rotates to the second position B (as shown in FIG. 4) due to the repelling magnetic force.

Next, the magnetic rotating member 21 is located at the second position B and the coil 4 conducts a second electric current that is in opposite direction of the first electric current, the two terminus of the yoke 3 formed via the first exciter portion 31 and the second exciter portion 32 generates magnetic that repels with the magnetic rotating member 21, so that the magnetic rotating member 21 rotates to the first position A (as shown in FIG. 3) due to the repelling magnetic force.

Furthermore, the swing shaft 212 of the magnetic rotating member 21 can be permanently installed with a leaf blade 5 (as shown in FIGS. 5 and 6), the leaf blade 5 rotates with the magnetic rotating member 21, and can selectively cover over the aperture 11 of the base frame 1. Therein, the leaf blade 5 can be a shutter blade, an aperture blade, or a filter blade.

As compared with the prior art, the rotator piece 2 of the present invention is a magnetic rotating member 21 formed in a one piece structure, therefore under equal volume condition, the magnetic rotating member 21 of the present invention would have a higher physical component structure ratio than the prior art. Therefore the magnetic rotating member 21 of the present invention has a better rotation effect when driven by the magnetic force of the yoke 3.

Additionally, the magnetic rotating member 21 design of the present invention allows for a higher degree of space utilization and component structural ratio than the prior art, therefore under the condition when a rotator piece needs to use magnet with an equal amount of volume, the magnetic rotating member 21 structure of the present invention is advantageous for decreasing the overall structural size of the rotator piece 2, and aids the design for miniaturizing a camera driving device.

Furthermore, the magnetic rotating member 21 is formed with magnetic particles and the binding agent being ejected and forming one unified piece, so forming the structure of magnetic rotating member 21 of the present invention only requires one manufacturing process, and therefore the present invention can effectively decrease the manufacturing difficulty and cost for forming the rotator piece 2.

### The Second Embodiment

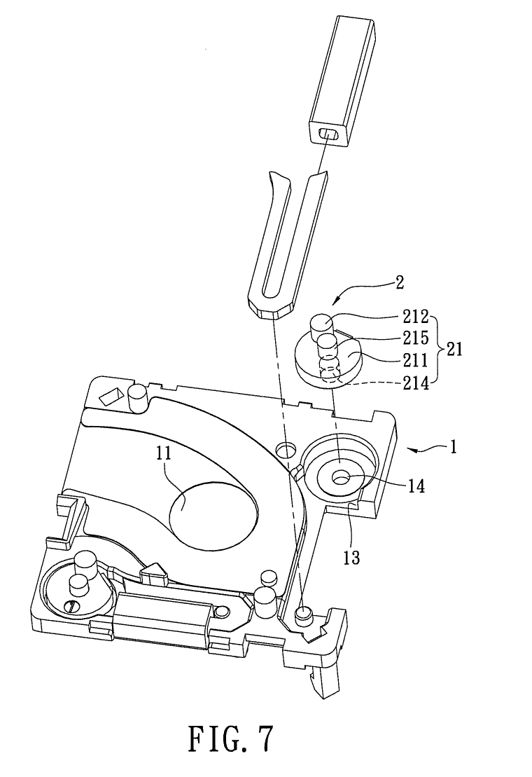

Reference FIG. 7, which shows a component assembly diagram according to a second embodiment of the present invention. The differences between the present embodiment and the first embodiment are described below.

Base frame 1 includes an aperture 11, a cylindrical shaped concave slot 14, and a container slot 13; the container slot 13 is connected with the concave slot 14. The rotator piece 2 is pivoted on the concave slot 13 of the case frame 1, and the rotator piece 2, the yoke 3, and the coil 4 is installed within the container slot 13.

The rotator piece 2 is a magnetic rotating member 21 structured in one piece, the magnetic rotating member 21 is formed with a base plate 211 and a swing shaft 212 extending from the base plate 211. Therein, the center of the base plate 211 extends to form a cylindrically shaped rotating shaft 214 that corresponds to the concave slot 14, the rotating shaft 214 and the swing shaft 212 respectively forms at the two opposite side of the base plate 211. The magnetic rotating member 21 is coupled to the concave slot 14 of the base frame 1 through the rotating shaft 214.

Furthermore, the other side of the base plate 211 corresponding to the rotating shaft 214 extends to form a positioning shaft 215, the swing shaft 212 and the positioning shaft 215 of the magnetic rotating member 21 can be permanently installed with a leaf blade (not shown), the leaf blade rotates with the magnetic rotating member 21, and can selectively cover over the aperture 11 of the camera base frame 1. Therein, the leaf blade can be a shutter blade, an aperture blade, or a filter blade.

Through the aforementioned structure design of the magnetic rotating member 21 (which includes the base plate 211, the swing shaft 212, the rotating shaft 214, and the positioning shaft 215 that are magnetic), the rotator piece 2 of the present embodiment only requires one processing sequence for manufacturing formation, additionally the design for the magnetic rotating member 21 of the rotator piece 2 allows for a high degree of space utilization and component structural ratio.

### Efficacy of the Embodiments

According to the embodiments of the present invention, the magnetic rotating member 21 of one piece structure has a better rotating effect when driven by the magnetic force of the yoke 3. Furthermore, the present invention is advantageous for decreasing the overall structural size of the rotator piece 2, and thereby aids the design for miniaturizing a camera driving device. Therefore, via the magnetic rotating member 21 structure of the present invention can effectively decrease the manufacturing difficulty and cost for forming the rotator piece 2.

In addition, When the magnetism of the magnetic rotating member needs to be increased or decreased and maintains the volume of the magnetic rotating member 21 at the same time, the amount of magnetic particles inside the magnetic rotating member 21 can be adjusted to change the strength of the magnetism.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A camera driving device, comprising:
a base frame;
a magnetic rotating member of integral one-piece construction having a base plate and a swing shaft extending from the base plate rotatably coupled to the base frame, wherein the swing shaft is positioned at a side of the base plate away from the base frame;
a yoke, installed at the base frame, and the two terminus of the yoke is positioned to one side of the magnetic rotating member; and
a coil for magnetic excitation wrappingly disposed on the yoke;
wherein, the swing shaft is rotatable between a first position and a second position,
wherein the magnetic rotating member is a bonding structure having a plurality of magnetic particles.

2. The camera driving device according to claim 1, wherein the base frame includes a convex axle, the base plate of the magnet forms an opening, and the magnet couples with the convex axle of the base frame through the opening.

3. The camera driving device according to claim 2, wherein the surrounding of the opening of the magnetic rotating member forms two opposing magnetic areas of a first magnetic pole and two opposing magnetic areas of a second magnetic pole, and the magnetic areas for the first magnetic pole and the second magnetic pole are arranged in a crisscross way.

4. The camera driving device according to claim 3, wherein when the coil is not conducted, the magnetic rotating member is located at the first position; when the coil conducts a first electric current, the magnetic rotating member is located at the second position; and when the coil conducts a second electric current that is in opposite direction of the first electric current, then the magnetic rotating member is located at the first position.

5. The camera driving device according to claim 1, wherein the base frame forms a concave slot, the base plate of the magnetic rotating member extends to from a rotating shaft, the rotating shaft and the swing shaft respectively forms at the two opposite side of the base plate, the magnetic rotating member is coupled to the concave slot of the base frame through the rotating shaft, and the other side of the base plate corresponding to the rotating shaft extends to form a positioning shaft.

6. The camera driving device according to claim 1, wherein the yoke forms a first exciter portion and a second exciter portion that connects with the first exciter portion, the first and second exciter portion respectively includes an inner terminus, an outer terminus, and an end surface that connects with the inner terminus and the outer terminus.

7. The camera driving device according to claim 6, wherein the outer terminus of the first exciter portion and the second exciter portion is longer than the inner terminus, the end surface of the first exciter portion and the second exciter portion presents an arc-shaped curved surface that is recessed inward.

8. The camera driving device according to claim 1, wherein the volume of the magnetic particles divided by the volume of the magnetic rotating member is approximately 0.2 to 0.9.

9. The camera driving device according to claim 1, wherein the volume of the magnetic particles divided by the volume of the magnetic rotating member is approximately 0.5 to 0.7.

10. A camera driving device, comprising:
a base frame; and
a magnetic rotating member of integral one-piece construction having a base plate portion and a swing shaft portion extending from the base plate portion rotatably coupled to the base frame,
wherein the swing shaft is positioned at a side of the base plate that is away from the base frame,
wherein the plate portion of the magnetic rotating member has two opposing magnetic areas of a first magnetic pole and two opposing magnetic areas of a second magnetic pole, the magnetic areas for the first magnetic pole and the second magnetic pole are arranged in a crisscross manner, and
wherein the swing shaft portion is rotatable between a first position and a second position,
wherein the magnetic rotating member is a bonding structure having a plurality of magnetic particles.

11. The camera driving device according to claim 10, wherein the base frame includes a convex axle, the base plate of the magnetic rotating member forms an opening, and the magnetic rotating member couples with the convex axle of the base frame through the opening.

12. The camera driving device according to claim 10, wherein the base frame forms a concave slot, the base plate of the magnetic rotating member extends to form a rotating shaft, the rotating shaft and the swing shaft respectively forms at the two opposite side of the base plate, the magnetic rotating member is coupled to the concave slot of the base frame through the rotating shaft, and the other side of the base plate corresponding to the rotating shaft extends to form a positioning shaft.

13. The camera driving device according to claim 10, wherein the volume of the magnetic particles divided by the volume of the magnetic rotating member is approximately 0.2 to 0.9.

14. The camera driving device according to claim 10, wherein the volume of the magnetic particles divided by the volume of the magnetic rotating member is approximately 0.5 to 0.7.
